(19) United States
(12) Patent Application Publication
(10) Pub. No.: US 2004/0157052 A1
(43) Pub. Date: Aug. 12, 2004

(54) Method for producing plastic glazing

(76) Inventors: Rym Benyahia, Bobigny (FR); Pascal Lefevre, Manicamp (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/469,540

(22) PCT Filed: Mar. 6, 2002
(86) PCT No.: PCT/FR02/00802

(30) Foreign Application Priority Data
Mar. 9, 2001 (FR) 01/03810

(51) Int. Cl. B29C 45/14; B32B 3/06

(52) U.S. Cl. 428/332; 264/484; 264/250; 264/259

(57) ABSTRACT

The invention relates to a method of manufacturing a product which is at least partly transparent and of high optical quality comparable to that of glazing, in which a sheet is placed in at least part of the bottom of a mould, the sheet being of corresponding shape and thermally insulating, then a thermoplastic capable of being fastened to the said sheet in the said product is injected into this mould.

The process is distinguished by the fact that the part of the mould whose bottom is provided with the said sheet is kept at a temperature less than that which would be necessary in the absence of the said sheet in order to give the required optical quality.

Moreover, the invention relates to the product obtained in this way, to its application as glazing thus obtained for a motor vehicle.

The present invention relates to the manufacture of mainly two-dimensional, almost flat products made of plastic having a relatively complex shape and being at least partly transparent, which, because of their high optical quality, are suitable for an application such as glazing.

Although glass can be difficult to replace in the majority of its applications in glazing for buildings, furnishings, domestic electrical appliances (oven doors, etc.), urban furniture or transport vehicles, its replacement, particularly by transparent plastics, has been envisaged in some of these applications.

The benefit of such plastics of the polycarbonate type compared to glass resides especially in the possibility of producing products having more varied and complex shapes, moving further away from planar geometry, and of integrating a larger number of functionalities into the product. This possibility is especially inherent to the injection moulding method.

Care should of course be taken to preserve the optical quality of the glazing and the mechanical properties required. To this end, the plastics differ from glass by superior scratchability necessitating the use of a scratch-resistant coating and by lower rigidity; this latter property requires the glazing to be stiffened by the formation of overthicknesses, or the use of metal inserts or equivalents, but conversely, allows simplified mounting modes, especially in the case of mounting in a body opening, because of the fact that the glazing can be deformed, or that it can easily be equipped with peripheral inserts for mounting, in the form of metal lugs or the like.

In the context of this invention, reference will particularly be made to plastic glazing obtained by a series of operations consisting in:

forming a scratch-resistant coating which is possibly in an intermediate state of cure on a substantially flat polycarbonate film or the like,

thermoforming this film while possibly continuing to cure the scratch-resistant coating,

placing this film at the bottom of a mould such that the scratch-resistant coating is in contact with the wall of the mould, and

combining with the film the material forming the core of the glazing by injection moulding, hot pressing, etc.

Alternatively, the polycarbonate film is provided with a scratch-resistant coating after having been shaped.

This technology is depicted by documents WO 99/03678 and WO 99/65678, the latter moreover relating to the injection of an additional material, chemical in nature and having different properties, by means of a single improved mould, making it possible to implement dual- or multi-injection moulding. This additional material constitutes, for example, a peripheral elastomer seal, a rear-view-mirror seating, etc.

Within the context of this technique, when a thermoplastic, for example a polycarbonate, is injected, it is necessary to heat the wall of the mould by circulating pressurized water at a temperature ranging from 90 to 120° C., since sudden cooling of the material injected at 300° C. on contact with the lower-temperature wall of the mould could have the effect of creating irregularities in the injected material, inevitably affecting the optical quality of the product.

It has unexpectedly been noticed that in implementing the teaching of the aforementioned documents WO 99/03678 and WO 99/65678, the fact of placing the thermoformed film at the bottom of the mould, in the parts where transparency and high optical quality of glazing are required, would make it possible to substantially reduce the wall temperature of the mould, while preserving the best optical quality, provided the film is a thermal insulator. Thus, by decreasing the temperature of the mould from 120° C. to 60° C., for example, in the case of injection moulding a polycarbonate, the supply of heat by a circulating hot fluid (water, oil, etc.) is decreased, saving energy.

The subject of the invention is therefore a method of manufacturing a product which is at least partly transparent and of high optical quality comparable to that of glazing, in which a sheet is placed in at least part of the bottom of a mould, the sheet being of corresponding shape and thermally insulating, then a thermoplastic capable of being secured to the said sheet in the said product is injected into this mould, a method which is distinguished by the fact that the part of the mould whose bottom is provided with the said sheet is kept at a temperature less than that which would be necessary in the absence of the said sheet in order to give the required optical quality.

In the sense of the invention, the fact of placing in the bottom of the mould a sheet of corresponding shape generally refers to prepositioning a sheet so as to closely match the bottom of the mould, it being possible for this sheet to support, on its surface of contact with the mould, a scratch-resistant coating in an intermediate or complete state of cure. Furthermore, the polycarbonates frequently used to form this sheet, as with many equivalent polymers, are thermally insulating in a manner well known to experts in the field.

One or more sheets are capable of being positioned at the bottom of the mould; according to two frequent embodiments, one sheet is placed at the bottom of the movable part of the mould, and if necessary, one at the bottom of the fixed part.

Products of excellent optical quality are obtained, with a substantial decrease in the supply of heat energy to the walls of the mould. Furthermore, it is easier to apply the sheet to the bottom of the colder mould.

An additional advantage is provided by the invention when the sheet adheres to the bottom of the mould, before the injection operation itself, by electrostatic means: this adhesion is then effectively increased.

The said sheet advantageously has a thickness of at least 100 μm, preferably at least 200 μm and, in a particularly preferred manner, at least 250 μm. These values are not essential but guarantee that the aforementioned remarkable effects of the invention are obtained to a high degree.

According to another characteristic, the thickness of the sheet is at the most 1000 μm, preferably at the most 850 μm and, in a particularly preferred manner, at the most 750 μm, these thicknesses being enough to allow the incorporation of all the desired functionalities which will be described below, while allowing easy manipulation and thermoforming of the sheet.

Preferably, the sheet is monolithic or multilayer and comprises one or more of the polymers chosen from polycarbonate, polypropylene, polymethyl methacrylate, ethylene/vinyl acetate copolymer, polyethylene glycol terephthalate, polybutylene glycol terephthalate, polyurethane, polyvinyl butyral, cycloolefin copolymers of the ethylene/norbornene or ethylene/cyclopentadiene type, polycarbonate/polyester copolymer, ionomeric resin such as ethylene/(meth)acrylic acid copolymer neutralized by a polyamine, and the like, alone or as a blend.

The injection moulded thermoplastic is identical to or different from that constituting the layer of the thermoformable sheet with which it comes into contact; it is preferably chosen from those mentioned above for the sheet, except for polypropylene and polyvinyl butyral, alone or as a blend. According to one embodiment of considerable practical benefit, this material is polycarbonate based, and the part of the mould whose bottom is provided with the said sheet is kept at a temperature of at the most 100° C., preferably at the most 80° C. and, in a particularly preferred manner, at the most 65° C.

Furthermore, the remarkable optical quality of the product is enhanced by the fact that, in the method of the invention, the sheet is thermoformed in advance as required, when the bottom of the mould is not of substantially flat shape, then kept at the bottom of the mould by any suitable means, especially by suction and/or blowing means and/or preferably by an electrostatic effect, before injecting the thermoplastic. The last measure aims to set up close contact between the sheet and the bottom of the mould, free from folds; such a contact is even better, in the case of implementing the electrostatic effect, the more effective the latter when the temperature of the bottom of the mould is lowered according to the invention, as mentioned above.

The subject of the invention is also a product which is at least partly transparent and of high optical quality comparable to that of glazing, obtained by the method described above, in which the said thermoplastic is injection moulded, in the transparent part of the said product, with a thickness of between 1 and 10 mm. These values are compatible with obtaining mechanical properties, in particular rigidity, which are good enough and a gain in mass per unit area with respect to the glass.

According to other features of the product of considerable practical benefit:

the said thermoplastic is injected with an overthickness stiffening the periphery of the product and/or thereby forming protrusions such as lugs for positioning or fastening the product and/or with elements, especially metallic elements, being inserted, for an electrical connection;

the said sheet supports a scratch-resistant layer;

the said sheet comprises a hydrophobic/oleophobic function incorporated in the scratch-resistant layer, or grafted thereonto or covering the latter with the insertion of a plastic film supporting the hydrophobic/oleophobic layer;

the said sheet comprises, over all or some of its surface, a decorative and/or masking layer, preferably positioned directly under the layer constituting the said sheet supporting the said scratch-resistant layer;

the said sheet comprises one or more optically selective layers;

the said sheet comprises a layer with a compositional gradient or a stack of antireflection layers;

the said sheet comprises a layer or a network of electrically conducting wires, capable of taking on the demisting/defrosting function by heating, or the antenna function.

The particular feature of the invention, consisting in lowering the temperature of the mould, does not lead to any particular development for obtaining these features, which is moreover described in many documents, including the aforementioned two applications, and consequently, is known to experts within the field and is easily within their scope.

Other objects of the invention are:

the application of the above product as glazing for buildings, furniture (showcases, shelving, shower cubicle, etc.), domestic electrical appliances, urban furniture (bus shelters, advertising panels, etc.), land-borne, sea-going and aeronautical transport vehicles;

glazing for a motor vehicle, obtained by the method above, especially a windscreen or, preferably, a side window or a rear window, a sunroof and/or a panoramic roof.

The invention is illustrated by the following example.

### EXAMPLE

The scratch-resistant coating described in the example in Patent Application EPP-A1-0 718 348 is deposited as a 20 μm thick liquid film on an 80 μm thick film of standard polycarbonate prepared from bisphenol A, sold by General Electric under the registered trademark “Makrolon”, which has a glass transition temperature T_{g} equal to 145° C., by flow coating. After drying, this thickness is reduced to 5 μm.

The coated support film is then placed in the bottom of a mould, the scratch-resistant layer being positioned on top; the assembly is subjected to a heat treatment at 155° C. for 30 min. A thermoformed sheet is thus formed.

The sheet is then placed at the bottom of an injection mould so that the scratch-resistant layer is in contact with the mould wall heated by means of a flow of water at 60° C. A 5 mm thick layer of thermoplastic of the same standard polycarbonate as that constituting the film supporting the scratch-resistant layer is then injected.

The layered structure obtained has excellent transparency and optical quality.

When carried out in the absence of the thermoformed sheet, all other operating conditions being identical, this injection makes it possible to obtain only a product whose surface has irregularities and mediocre optical quality, including a loss of transparency and distortion or diffraction of the light.

1. Method of manufacturing a product which is at least partly transparent and of high optical quality comparable to that of glazing, in which a sheet is placed in at least part of the bottom of a mould, the sheet being of corresponding shape and thermally insulating, then a thermoplastic capable of being secured to the said sheet in the said product is injected into this mould, characterized in that the part of the mould whose bottom is provided with the said sheet is kept at a temperature less than that which would be necessary in the absence of the said sheet in order to give the required optical quality.

2. Method according to claim 1, characterized in that the said sheet has a thickness of at least 100 μm, preferably at least 200 μm and, in a particularly preferred manner, at least 250 μm.

3. Method according to claim 1 or 2, characterized in that the said sheet has a thickness of at the most 1000 μm, preferably at the most 850 μm and, in a particularly preferred manner, at the most 750 μm.

4. Method according to one of the preceding claims, characterized in that the said sheet is monolithic or multilayer and comprises one or more of the polymers chosen from polycarbonate, polypropylene, polymethyl methacrylate, ethylene/vinyl acetate copolymer, polyethylene glycol terephthalate, polybutylene glycol terephthalate, polyurethane, polyvinyl butyral, cycloolefin copolymers of the ethylene/norbornene or ethylene/cyclopentadiene type, polycarbonate/polyester copolymer, ionomeric resin such as ethylene/(meth)acrylic acid copolymer neutralized by a polyamine, and the like, alone or as a blend.

5. Method according to one of the preceding claims, characterized in that the said injected thermoplastic is chosen from polycarbonate, polymethyl methacrylate, ethylene/vinyl acetate copolymer, polyethylene glycol terephthalate, polybutylene glycol terephthalate, polycarbonate/polyester copolymer, polyurethane, cycloolefinic copolymers of the ethylene/norbornene or ethylene/cyclopentadiene type, ionomeric resin such as ethylene/(meth)acrylic acid copolymer neutralized by a polyamine, and the like, alone or as a blend.

6. Method according to claim 5, characterized in that the said injection moulded thermoplastic is polycarbonate based, and in that the part of the mould whose bottom is provided with the said sheet is kept at a temperature of at the most 100° C., preferably at the most 80° C. and, in a particularly preferred manner, at the most 65° C.

7. Method according to one of the preceding claims, characterized in that the said sheet, having been thermoformed in advance as required, is kept at the bottom of the mould by any suitable means, especially by suction and/or blowing means and/or preferably by the electrostatic effect, before injecting the said thermoplastic.

8. Product which is at least partly transparent and of high optical quality comparable to that of glazing, obtained by the method according to any one of the preceding claims, in which the said thermoplastic is injection moulded, in the transparent part of the said product, with a thickness of between 1 and 10 mm.

9. Product according to claim 8, characterized in that the said thermoplastic is injected with an overthickness stiffening the periphery of the said product and/or thereby forming protrusions such as lugs for positioning or fastening the said product and/or with elements, especially metallic elements, being inserted, for an electrical connection.

10. Product according to claim 8 or 9, characterized in that the said sheet supports a scratch-resistant layer.

11. Product according to claim 10, characterized in that the said sheet comprises a hydrophobic/oleophobic function incorporated in the scratch-resistant layer, or grafted thereonto or covering the latter with the insertion of a plastic film supporting the hydrophobic/oleophobic layer.

12. Product according to claim 10, characterized in that the said sheet comprises, over all or some of its surface, a decorative and/or masking layer, preferably positioned directly under the layer constituting the said sheet supporting the said scratch-resistant layer.

13. Product according to one of claims 8 to 12, characterized in that the said sheet comprises one or more optically selective layers.

14. Product according to one of claims 8 to 13, characterized in that the said sheet comprises a compositional layer with a gradient or a stack of antireflection layers.

15. Product according to one of claims 8 to 14, characterized in that the said sheet comprises an electrically conducting network.

16. Application of a product according to one of claims 8 to 15 as glazing for buildings, furniture, domestic electrical appliances, urban furniture and land-borne, sea-going and aeronautical transport vehicles.

17. Glazing for a motor vehicle, obtained by the method according to one of claims 1 to 7.
